(19) United States
(12) Patent Application Publication
(10) Pub. No.: US 2008/0136134 A1
(43) Pub. Date: Jun. 12, 2008

(54) Zero turning radius vehicle control mechanism

(76) Inventors: Trevor Albert McCoid, Auckland (NZ); David Edward White, Auckland (NZ)

Correspondence Address: JACOBSON HOLMAN PLLC, 400 SEVENTH STREET N.W., SUITE 600, WASHINGTON, DC, 20004, US

(21) Appl. No.: 11/984,328

(22) Filed: Nov. 15, 2007

Related U.S. Application Data
(60) Provisional application No. 60/907,613, filed on Apr. 11, 2007.

(30) Foreign Application Priority Data
Nov. 15, 2006 (NZ) 551363

(51) Int. Cl. G05G 13/00; B62D 7/00; B62D 1/02

(52) U.S. Cl. 280/93.502; 74/484 R; 180/315

(57) ABSTRACT

A zero turning radius vehicle is disclosed that has a steering and drive control mechanism that includes a steering wheel and an accelerator pedal. The mechanism includes push-pull rods to effect movement of throttle levers on motors that independently drive traction elements such as wheels or traction belts. The position of each push-pull rod can be controlled by both the steering wheel and the accelerator pedal such that both the wheel and accelerator pedal can control the throttle of each motor independently or proportionally to thereby effect a change in vehicle speed and/or direction of travel.

### FIELD OF THE INVENTION

The present invention relates to zero turning radius vehicle control mechanism, and in particular a steering and drive control arrangement for a zero-radius turning vehicle.

### BACKGROUND OF THE INVENTION

The use of zero radius turn vehicles is well known in several industries. In particular, they are well known for use in tracked armoured vehicles, and for ride-on lawn mowers. The use of zero radius turn vehicles is particularly advantageous where the vehicles are required to move in tight or confined spaces, or where they are required to follow staggered lines of movement.

The steering control systems used with these vehicles usually involve a pair of levers that each control the forward or backward movement of a wheel or drive system to a wheel. By pushing or pulling on each lever, the corresponding wheel of drive system (such as a track) is caused to move forwards or backwards respectively, and by pushing on one lever while pulling on another, the vehicle may be made to turn up to 360 degrees around an axis at the centre of the wheels.

A disadvantage of this system is that it is not immediately intuitive for a new driver to be able to control the vehicle. This is because the control system does not resemble those of vehicles that are used in an everyday environment (i.e. it does not involve a steering wheel or a foot pedal system).

Attempts have been made to create more intuitive control systems for zero radius turn vehicles. In one such attempt, each lever has been connected to a lever arm, and each lever arm has in turn been connected to an axle on which a steering wheel has been placed. The steering wheel is movable forwards and backwards to control forward and backward movement of the vehicle, while movement of the steering wheel from one side to another will cause a change in relative movement of the levers, thereby creating a turning motion in the vehicle.

### SUMMARY OF THE INVENTION

The term “traction means” as used in this specification is defined as denoting any wheel, carriage or track system associated with a vehicle that is suitable to move a vehicle along by its tractive effort on a surface.

For the purposes of this specification, the term “vehicle chassis” is defined to mean any part of a vehicle which is part of, connected to, secured to, engaged with, or coupled to the main supporting frame of that vehicle.

It is an object of this invention to provide a steering and drive control arrangement that at least partially overcomes the abovementioned disadvantages and/or difficulties, or which will at least provide the public with a useful choice.

Accordingly, in a first aspect the present invention is a steering and drive control mechanism for a zero turn radius vehicle having a vehicle chassis and a pair of transmission systems for independently driving at least two traction elements that are spaced from each other and each defining two parallel drive directions for driving said vehicle, said steering and drive control mechanism comprising
a drive assembly comprising
   a pivoting member mounted to pivot about a pivot axis relative said chassis,
   a pair of control linkage members engaged to the pivoting member in a movable manner so that the connection point for each control linkage member with said pivoting member can be moved relative said pivot axis, each said control linkage member in operative connection with a respective transmission systems to control the respective transmission system,
a foot operated pedal assembly, operatively coupled to the drive assembly so that movement of the pedal assembly results in pivotal movement of the pivoting member about the pivot axis;
a steering member pivotally connected to the vehicle chassis,
a steering assembly coupling the steering member with the control linkage members so that pivoting movement of the steering member can vary the position of one or both of the connection points of the control linkage members relative the pivot axis to thereby effect a change in operation of one of both of the transmission systems.

Preferably, the location of each of the connection points at the pivoting member of each of the control linkage members can be varied independently.

Preferably, the location of each of the connection points at the pivoting member of each of the control linkage members can be varied by movement of the steering member between a position at which the connection points of both control linkage members is displaced in the same direction (and preferably at same distance) from the pivot axis of the pivoting member, to a position wherein the pivot point is intermediate of the two connection points (and are preferably spaced equidistant from the pivot point).

Preferably, the pivoting member and the control linkage members are movably connected to each other to allow a fixed locus displacement of the control linkage members relative the pivot axis.

Preferably, steering and drive control mechanism as claimed in any one of claims 1 to 4 wherein said pivoting member and each said control linkage member are connected via
a cam follower; and
a cam
the cam follower being pivotably and slideably moveable relative said cam.

Preferably, said cam follower is fixed to the control linkage member and said cam is part of the pivoting member.

Preferably, a said cam follower is engaged towards a distal end of each of the control linkage members.

Preferably, the cam is a slot defined by the pivoting member into which the cam follower is located.

Preferably, said slot is of a shape to result in a movement of each of said control linkages members upon the pivoting of said pivoting member about the pivot axis.

Preferably, said movement is a displacement that includes a radial direction displacement relative said pivot.

Preferably, for each cam follower a separate cam is provided.

Preferably, the pivot axis may pass though the cam.

Preferably, said cam is a slot, the pivot axis passes through said slot midway between distal ends of said slot.

Preferably, biasing means is provided to bias the control linkage members to a location relative the pivoting member where the location of the connection points in the same distance from the pivot axis.

Preferably, the steering assembly may include
a pivotable steering column on which the steering member is mountable;
a pair of steering arms connected to the steering column; each said steering arms being operatively connected by a respective coupling member to said a said control linkage member so that movement of the steering member causes pivotal movement of the steering arms through the steering column, and hence a displacement of the control linkage member relative said pivoting member.

Preferably, each said control linkage member is mounted relative said chassis by a mount that allow the control linkage member to displace in a manner rotationally unconstrained by said mount upon (a) the rotation of said pivoting member about the pivot axis and/or (b) movement of the steering member to vary the position of one or both of the connection points of the control linkage members relative the pivot axis.

Preferably, said steering assembly includes a lost motion mechanism that allows steering assembly induced movement of one of the control linkage members whilst leaving idle the other control linkage member and visa versa.

Preferably, the lost motion mechanism includes a primary arm mounted to positively rotate about a rotational axis in response to rotation of the steering member and two independent link arms rotationally mounted about said rotational axis, said primary arm including two stoppers intermediate of which said rotational axis is located, each stopper presented to engage with a respective link arm to displace said link arm in one direction of rotation about said rotational axis without acting on the other link arm, each said link arm coupled to a respective control linkage member.

Preferably, the traction elements be wheels.

In a second aspect, the present invention is a zero turning radius lawnmower that includes the steering and drive control mechanism as defined above.

In a third aspect, the present invention is a zero turning radius lawnmower, said lawnmower comprising
a pair of transmissions to drive at least two drivers independently of each other;
a chassis;
a steering and drive control mechanism as defined above.

Preferably, the steering member is a steering wheel.

In a fourth aspect, the present invention is a steering and drive control mechanism, suitable for a vehicle that includes a vehicle chassis and at least two traction elements that are spaced from each other and each define two parallel drive directions, each said traction element associated with a respective transmission system for independently driving said traction element, each said transmission system providing a rotational input to said respective traction elements in response to movement of a controller, wherein said mechanism comprises:
for each said transmission system, a control linkage member to effect movement of the controller resultant from linear displacement of the respective control linkage member,
each said control linkage member pivotable about a pivot axis fixed relative to said chassis and biased towards one rotational direction, each control linkage member movable as a result of two inputs, namely
   (i) a steering wheel that can vary the rotational disposition of each said control linkage member relative each other about said pivot,
   (ii) an accelerator actuator that is movably mounted to said chassis to effect a rotation of a pivoting member about a pivot axis (herein after “second pivot axis”), said pivoting member including for each said control linkage member, a cam surface that has a first and second distal end and that is rotatable about said second pivot axis, said cam surface acting on said control linkage member via a cam follower to linearly displace its respective control linkage member.

Preferably, steering wheel that can vary the rotational disposition of each said control linkage member relative each other about said pivot, via a lost motion linkage between said steering wheel and each said control linkage members that:
(a) in one rotational direction of the steering wheel, can move one of said control linkage members, but not the other control linkage member, and
(b) in an opposite rotational direction of the steering wheel, can move the other said control linkage members, but not the one control linkage member.

Preferably, rotational displacement of a said linkage control member by said steering wheel will result in a displacement of the cam follower between the first and second distal ends of the cam.

Preferably, displacement along the cam may also result in a linear displacement of the linkage control member.

Preferably, the cam is accurate shaped and has a centre coinciding with the first mentioned pivot axis at one rotational orientation of the pivot member.

Preferably, in said one rotational orientation, pivotal movement of either of the control linkage members by the steering wheel will not result in a linear displacement of the control linkage member.

Preferably, both said control linkage members are biased towards one of the first and second distal ends of their respective cam.

Preferably, the lost motion mechanism will result in a displacement of only one of the two control linkage members away from its favoured end of the respective cam at any one time.

Preferably, both cams have their centre off set from said pivot, at any rotational position of the pivot member other than said one rotational orientation.

Preferably, a movement of a linkage control member by said steering wheel when said pivot member is any rotational position other than at said one rotational orientation will result in a linear displacement of said linkage control member.

Preferably, when said pivot member is in said one rotational condition, said ends of each said cam are positioned on either side a notional line through said pivot axis and second pivot axis.

In a fifth aspect, the present invention is a vehicle that includes a drive and steering control arrangement as defined above.

Preferably, the vehicle is a zero turning radius vehicle.

Preferably, said vehicle includes idler wheels in addition to the traction elements that drive and steer said vehicle.

Preferably, the vehicle is a lawnmower.

In a sixth aspect, the present invention is a vehicle that includes two transmissions one each for a traction element that is located to move said vehicle in a forward and backward direction in cooperation with the other traction element, said traction elements having a drive direction that is parallel the other and that is spaced from each other, where control of each transmissions occurs by the drive and steering control arrangement as defined above.

In a seventh aspect, the present invention is a control mechanism to control the speed and direction of travel of a vehicle that includes a steering wheel and an accelerator pedal, said vehicle capable of being propelled by two spaced apart traction elements each independently driven by a respective motor, the output torque of each motor controlled by a displaceable input device, said control mechanism comprising;

a first push-pull rod having a first distal end and a second distal end, said first distal end engaged to said input device of one of said motors (hereinafter “first motor”),

a second push-pull rod having a first distal end and a second distal end, said first distal end engaged to said input device of the other of said motors (hereinafter “second motor”),

a pivot member mounted from said vehicle pivotable about a pivot axis in a manner responsive to the position of the accelerator pedal, said pivot member including at least one lever arm to which and along at least part of which at least one of said first and push-pull rod members and second push-pull rod members can traverse by being slidingly coupled thereto at or towards said second distal end, such that when said pivot member is pivoted about pivot axis, the first push-pull rod can, when in at least one position along said lever arm, displace the input device of said first motor and said second push-pull rod can, when in at least one position along said lever arm, displace the input device of said second motor,

a first coupling member operatively extending between said steering wheel and said first push-pull rod and

a second coupling member operatively extending between said steering wheel and said second push-pull rod,

wherein the movement of said steering wheel is, via said coupling members, capable of displacing both said first push-pull rod and said second push-pull rod along said lever arm to displace first push-pull rod and/or said second push-pull rod relative said pivot axis to thereby change the effective lever arm effect of said pivot member on said first push-pull rod and/or said second push-pull rod and thereby vary its effect on its respective input device.

Preferably, the pivot member includes two lever arms, one for each of said first push-pull rod and said second push-pull rod, each said lever arm movable in unison.

Preferably, each said first and second push-pull rods are mounted in a pivotal manner to pivot about a respective pivot axis (hereinafter “rod pivot”) and the pivot member defines at said lever arm(s) a path of travel therealong for said first and second push-pull rods that is/are arcuate and the centre of the arc coincides, at least at one rotational position of said pivot member about its pivot axis, with said rod pivot, said one rotational condition corresponding with a parked condition of said vehicle such that any steering wheel actuated movement of the first and second push-pull rods along the arc does not displace a respective input device.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### BRIEF DESCRIPTION OF THE DRAWINGS

FIG. 1 is a perspective view of a vehicle, specifically a ride on lawn mower, incorporating a first embodiment of the invention;

FIG. 1a shows in detail part of the steering and drive control mechanism of the vehicle;

FIG. 2 is a schematic cutaway view showing an embodiment of the invention;

FIG. 3 is a schematic cutaway view showing a second embodiment of the invention with a different means of coupling the coupling members to the control linkage members;

FIG. 4 is a perspective view of the pedal assembly;

FIG. 5 is a top view of the pedal assembly shown in FIG. 4;

FIG. 6 is a view along the steering column showing the stopping bracket and steering arms;

FIG. 7 is a side view of the assembly shown in FIG. 6;

FIG. 8 is a perspective view of the assembly shown in FIG. 7;

Two embodiments of the invention are described separately below, having reference to different numerals and terminology.

FIG. 9 illustrates a view of transmission systems and traction elements that may be employed in the vehicle of the present invention,

FIG. 10 is a perspective view of part of a steering arrangement,

FIG. 10a is a perspective view of part of the steering arrangement,

FIG. 10b is a front view of some of the steering mechanisms employed in the steering arrangement of the present invention including a lost motion mechanism,

FIG. 10c is a sectional view of FIG. 10b,

FIG. 11 is a perspective view of part of the arrangement of the present invention,

FIG. 12 is a plan view of part of the arrangement,

FIG. 13 illustrates certain components of the mechanism of the present invention,

FIG. 14 illustrates certain components in a plan view,

FIG. 15 illustrates certain components in a side view,

FIG. 16 illustrates certain components in a side view,

FIG. 17-20 illustrates different positions of certain components of the present invention to illustrate control of the transmission elements, and

FIG. 21 shows a variation of the pivot member wherein one pivot arm (or lever arms as herein also referred to) that includes two sections, one for each control linkage members (herein also referred to as push-pull rods), the geometry set up so that steering and speed control can be achieved by the steering wheel and accelerator foot pedal.

### DETAILED DESCRIPTION OF PREFERRED EMBODIMENTS OF THE INVENTION

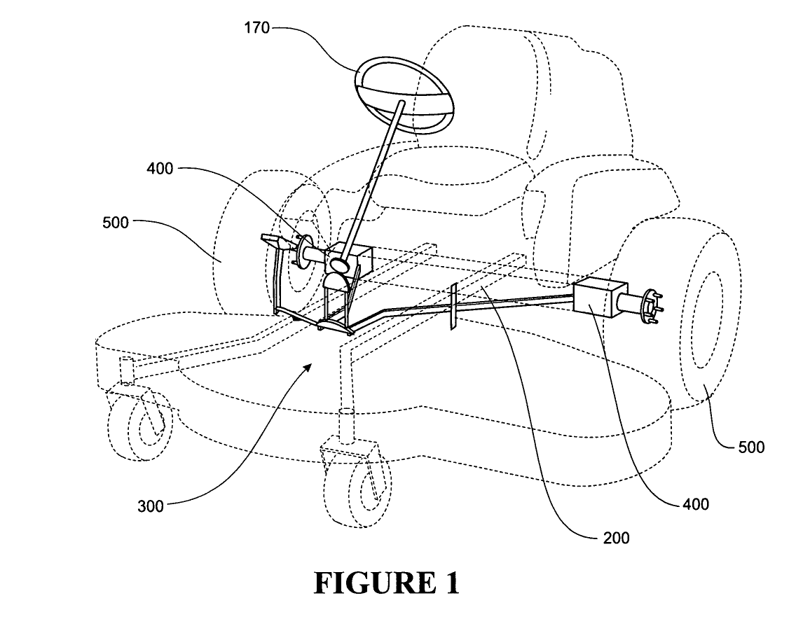

With reference to FIG. 1 there is shown a vehicle (e.g. a lawn mower) that includes a steering and drive control arrangement generally indicated by the numeral 300.

The steering and drive control arrangement 300 may be suitable for a vehicle having independent transmission systems to drive two traction elements such as in the form of driving wheels and a vehicle chassis 200.

A steering wheel 170 is pivotally connected to the vehicle chassis 200.

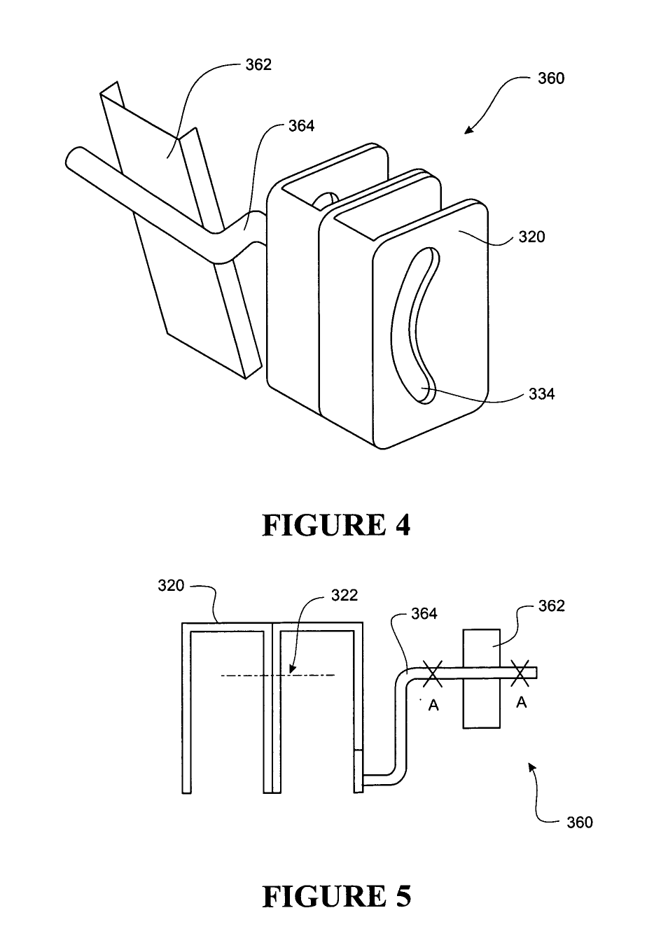

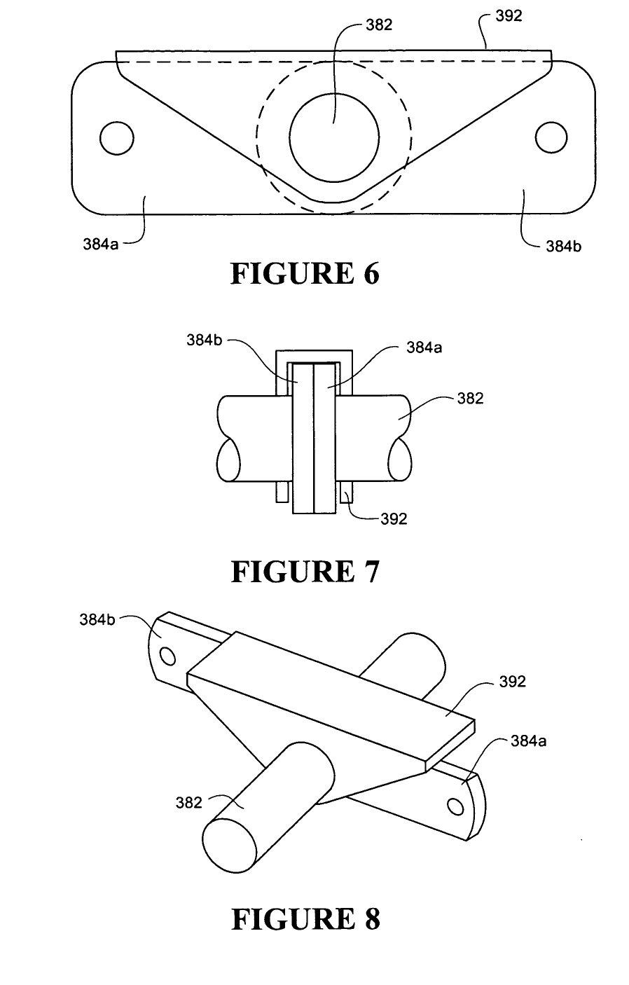

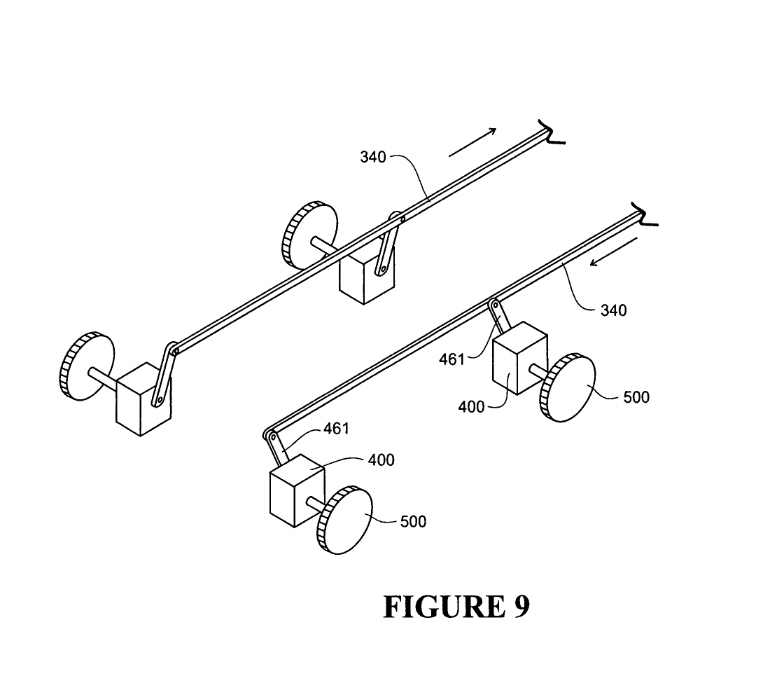

With reference to the FIGS. 1-8, a steering and drive control arrangement is generally indicated by the numeral 300.

The steering and drive control arrangement 300 is suitable for a vehicle having a vehicle chassis 200 and a pair of transmission systems for independently driving two traction elements such as drive wheels as herein before described.

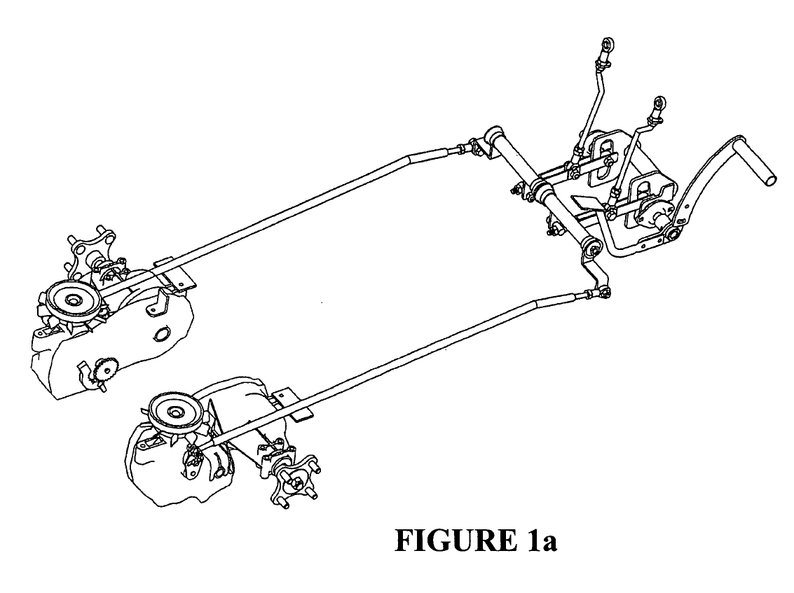

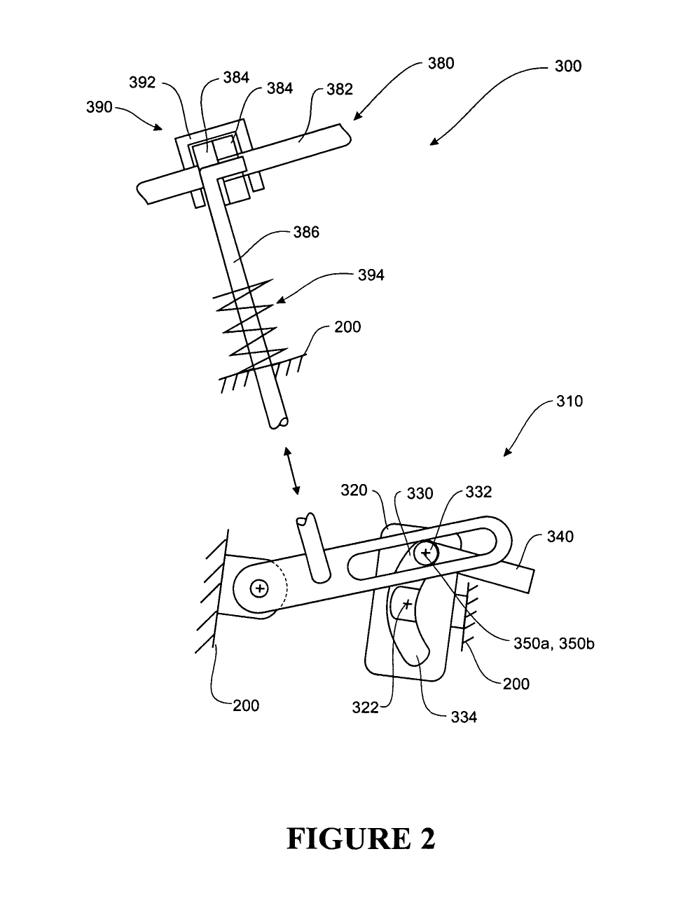

The control arrangement 300 comprises a drive assembly 310 including a pivot member 320, which is pivotally movable relative to the chassis around a pivot axis 322. The pivot member 320 is also movably connected to a pair of control linkage members 340 at a connection point 350a & 350 b for each control linkage member 340. Each control linkage member 340 is configured to actuate one of the transmission systems that will control one traction element or a number of traction elements on one side as for example shown in FIG. 2. The transmission system may include a motor that can drive a wheel and may include an input device that can adjust the speed of the motor.

The pivot member 320 is coupled to each of the control linkage members 340 by control formations 330. Each control formation 330 comprises a pivot pin 332; and a slot 334. The pivot pin 332 is pivotably and slideably moveable within the slot 334.

The pivot pin 324 is secured towards the end of each of the control linkage members 340. The pivot member 320 defines the pair of slots 322 or other cam like formation. The centre of each pivot pin 324 is the connection point 350 for each of the control linkage members 340.

The control arrangement 300 further comprises a foot operated pedal assembly 360, comprising a foot operable pedal 362 and a pedal connector member 364. The pedal assembly 360 is coupled to the drive assembly 310 so that movement of the pedal assembly 360 results in pivotal movement of the pivot member 320 about the pivot axis 322.

The control arrangement 300 further comprises a steering member in the form of a steering wheel 370 pivotally connected to the vehicle chassis 200. The steering member is coupled to the pivoting member 320 by a steering assembly 380. The steering assembly 380 comprises a pivotable steering column 382 on which the steering wheel is mounted, a pair of steering arms 384 connected to and extending laterally from the steering column 382; and a pair of coupling members 386 configured to each connect to a respective steering arms 384 and to a respective control linkage member 340.

The steering arms 384 are freely rotatable around the steering column 382, and are pivotably connected to the coupling members 386 to allow movement in a pivotal direction. In this way, pivotal movement of the steering wheel 370 causes pivotal movement of the steering arms 384 through the steering column 382, and causes substantially linear movement of the coupling members 386.

The coupling members 386 are in turn configured to connect the steering arms 384 to the control linkage members 340, so that rotational movement of the steering wheel varies the position of the connection points 350a and 350b of each control linkage relative to each other and relative on the pivoting member 320.

The steering assembly 380 may further comprise a lost motion mechanism 390 that allows movement of the coupling members 386 to move the position of one of the connection points 350a without corresponding movement of the other connection point 350b. The lost motion mechanism 390 includes a triangularly shaped stopping bracket 392 which is rigidly secured to the steering column 382. The stopping bracket 392 is configured to push against and move one of the steering arms 384 downwards when the steering wheel 370 is rotated, without pulling upwardly on the other steering arm 384. Other forms of lost motion mechanism may also be used.

It should be noted that the opposed steering arm, spring assembly and coupling member remain stationary, since the stopping bracket has no direct connection to this steering arm.

The steering assembly 380 further included biasing means in the form of spring assemblies 394 which bias the coupling members upwardly so that the connection points 350 of the pivot pins 332 in the slot 334 is biased towards one end of the slot 334.

In use, the operator (not shown) of the vehicle will turn the steering wheel 370 to turn the vehicle. As the steering wheel pivots, the steering column 382 and stopping bracket 392 will pivot with it the stopping bracket 392 will push one of the steering arms 384 downwards, against the force of the associated spring assembly 394. The movement of the steering arm 384 will cause the linear movement of the associated coupling member 386.

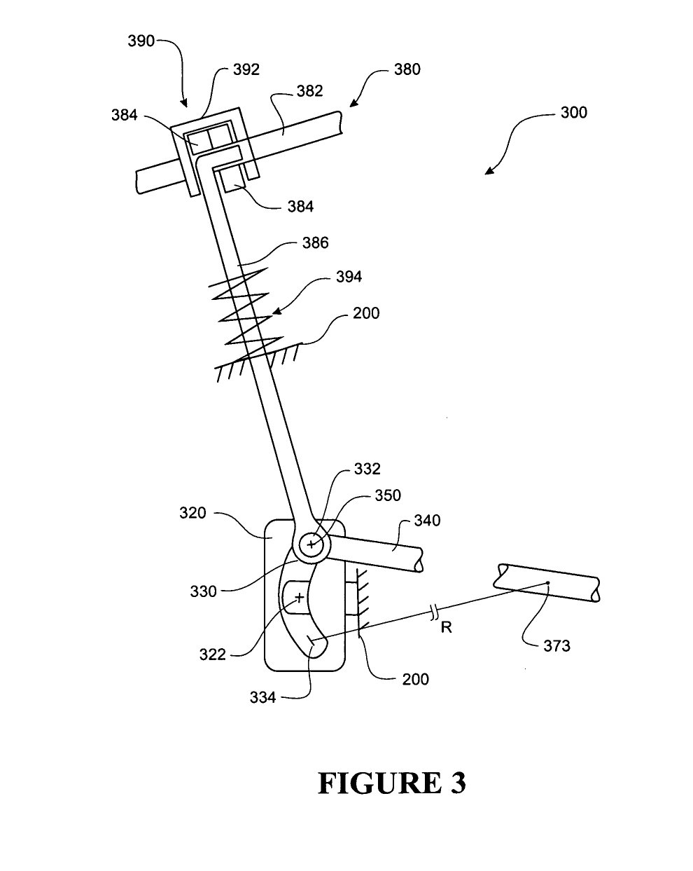

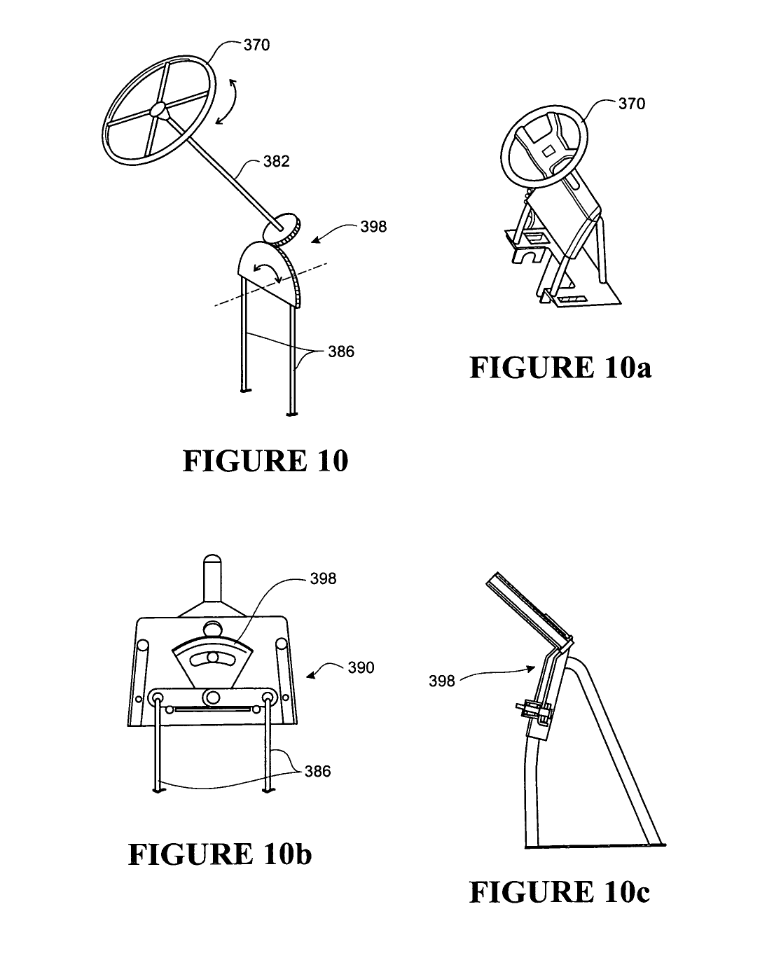

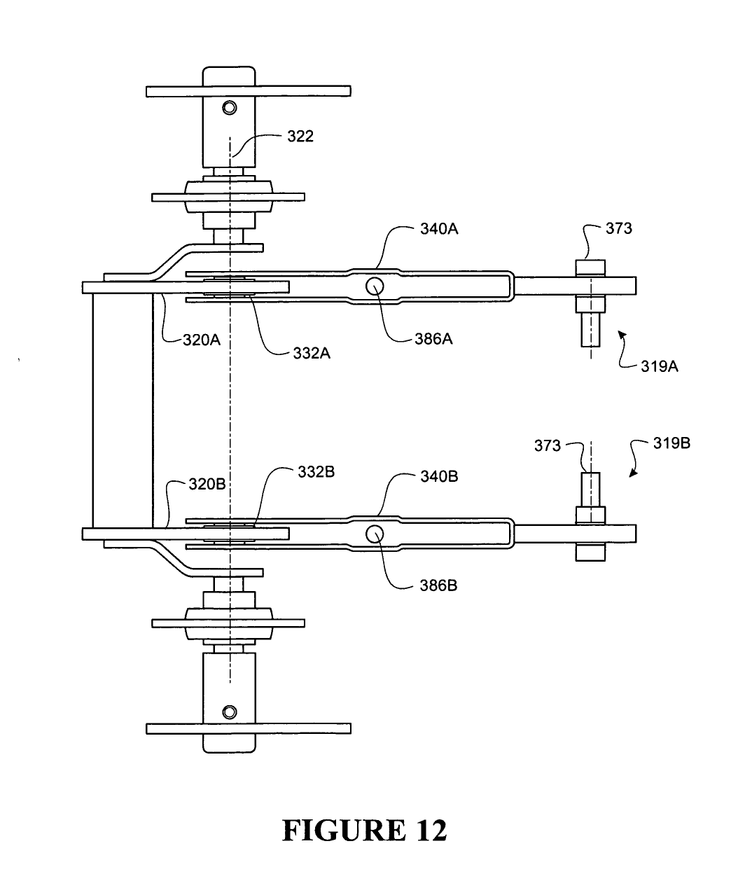

With reference to FIG. 10 there is shown a variation to the arrangement between the steering wheel 370 and the coupling members 386. In the example shown in FIG. 12, a rack and pinion mechanism 398 is utilised to effect a pull and/or push operation of each of the coupling members 386. With reference to FIGS. 2 and 3, the operation of the device and motion intermediate of the motion of each of the coupling members 386 is shown. An alternative arrangement to a rack and pinion may be a sprocket and chain arrangement. With reference to FIG. 10a, 10b and 10c there is shown an arrangement where a lost motion mechanism 390 is incorporated. The lost motion mechanism 390 is incorporated with a rack and pinion like arrangement as described with reference to FIG. 10 and for the same purposes.

In the reference frames of the drawings, as the coupling member 386 moves downwardly, it will move the associated pivot pin 332, and hence the associated connection point 350 from its biased position at the top of the associated slot 334, to a position closer to the pivot axis 322 of the pivot member 320. The control linkage members 340 are pivotable about their connection to each of the transmission systems. The slots 334 preferably follow and arc of the pivot pin 332 around the control linkage member's 340 pivoting axis 373. However, as shown with reference to FIG. 21 the slot or slots of the lever arm 510 of the pivot member 320 may be straight or of any shape. In FIG. 21 a variation is shown where one of the control linkage member 340 (also referred to as the push-pull rod) may consist of components parts that includes an intermediate pivot bar 511 that pivots about pivot 512. This variation in geometry can allow for both control linkage members to push and pull their respective inputs of the transmissions in unison. Alternative mechanical linkages and couplings are envisaged to fall within the scope of the invention.

Known transmission systems require linear actuation of their control linkages in a backwards or forwards manner to change the state of transmission of power from an engine to the vehicle wheels. FIG. 19 for example illustrates levers 461 for each of the transmissions 400 with which a control linkage member 340 can be coupled to effect therein movement.

When the steering wheel 370 is in its mid position, both of the connection points 350 will remain biased towards the top of their respective slots 334. When the pedal is pivoted by action of an operator, the resultant pivoting of the pivoting member 320 will cause equal linear motion backwards or forwards to both the control linkage members 340, thereby causing vehicle wheels on both sides of the vehicle to move backwards or forwards at similar speeds. In such a case, the vehicle will continue in a straight line in the forwards or reverse direction, depending on the direction of pivoting of the pivoting means 320.

As the steering wheel 370 is turned, one of the pivoting pins 332 moves along the slot 334 to a position different to the other e.g. closer to the pivot axis 322 of the pivoting member 320. Since this follows the arc of rotation of the pivot pin around the control linkage member's 340 pivoting axis, the control linkage member 340 will not be moved linearly backwards or forwards and there will be no effect on the associated transmission system until the pedal 362 is operated to cause movement of the pivoting member 320.

However, as soon as the pedal 362 is pivoted by action of the operator, this will cause the rotation of the pivoting member 320 around the pivot axis 322, thereby imparting linear movement to the control linkage member 340, causing it to actuate the associated transmission system to drive the associated vehicle wheel forwards or backwards.

The closer the moving pivot pin 332 is to the pivot axis, the less linear motion is imparted to its associated control linkage member 340.

The centre of the slots 334 is preferably aligned with the pivot axis 322 of the pivoting member 320. When the steering wheel is turned far enough to one side, the pivot pin 332 will move to a point where its axis coincides with that of the pivot member, while the opposed pivot pin 332 remains biased towards the top of the slot 334.

If the pivot member is pivoted by operation of the pedal 362 when the steering wheel 370 in such a position, linear motion will be imparted to the control linkage member 340 associated with the pivot pin 332 that has not been moved, causing the associated wheel to move forwards or backwards. No linear movement will be imparted to the linkage member 340 associated with the pivot pin 332 that has moved to coincide with the pivot axis 322, and the associated wheel will remain stationary. This combination of one stationary wheel and one moving wheel will cause the vehicle to turn.

As the steering wheel is turned even further, the moving pivot pin 332 will move along the slot 334 past the pivot axis 322. As it moves past the pivot axis 322, any pivotal movement of the pivoting member 320 will cause linear movement of the associated control linkage member 340 in an opposite direction to that of the opposed control linkage member 340. In such a case, the one wheel will move forward while the other wheel will move backwards, thereby causing the vehicle to turn in a decreased radius of turn.

When the moving pivot pin 332 reaches the opposite end of the slot 334, which is an equal radial distance from the pivot axis 322, the rate of forward motion of the one wheel will equal the rate of backward motion of the opposed wheel, and the vehicle will be carrying out a zero-radius turn. Other wheels provided on the vehicle may be castor wheels that can facilitate a zero radius turn.

Reference is herein made to the use of transmissions for each traction element such as a wheel. As part of each transmission there may be provided a motor or prime mover. Alternatively a single prime mover may be provided and may provide power for the operation of all of the traction elements. For example, a single hydraulic pump may be provided to deliver working fluid to hydraulic motors of each of the transmissions.

Preferably, the location of the connection points on the pivot member may be varied by movement of the steering member between a position at which the connection points of both control linkages is displaced at a similar direction and magnitude from the pivot axis of the pivoting member, to a position in which the connection points are aligned in a substantially radially opposite direction and magnitude from each other.

Preferably, the steering and drive control arrangement may include biasing means for biasing the control linkages, the steering assembly, the coupling members or any combination of these in order to locate the positions of the connection points in similar positions relative to the pivot axis.

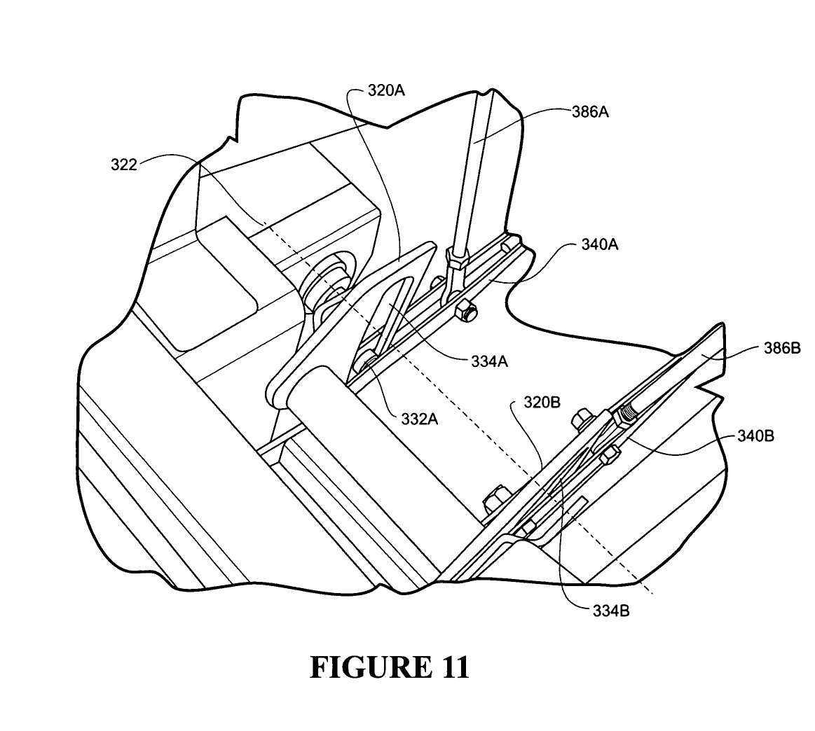

With reference to FIGS. 11-16 a further explanation is made in respect of the preferred embodiment with some slight variations to that already explained.

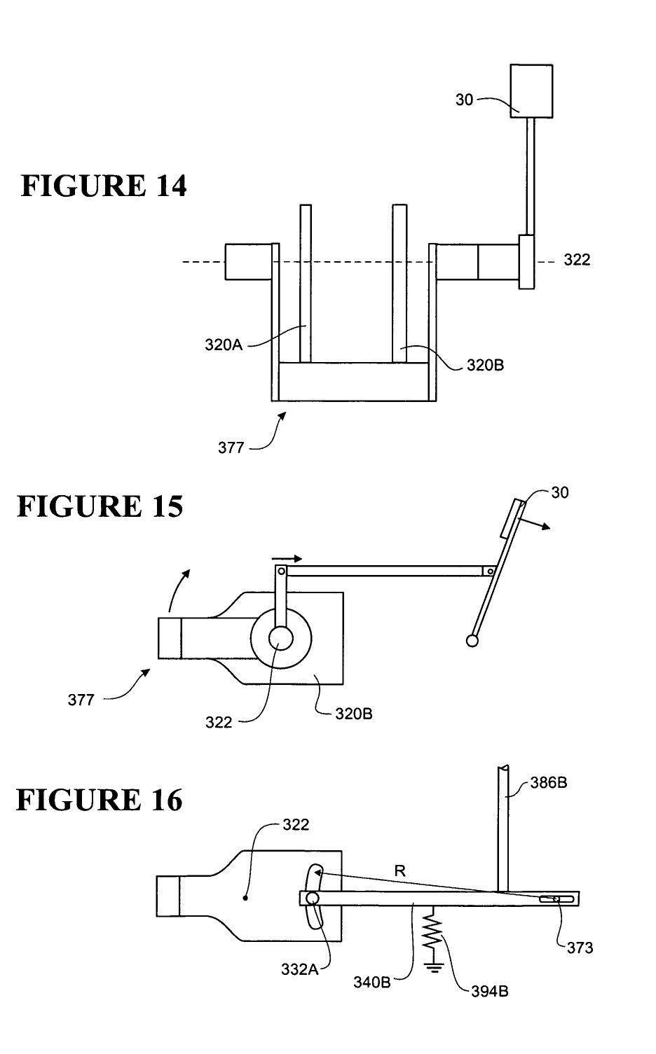

FIG. 11 shows two pivot members 320a and 320b. Each pivot member may effect linear displacement of the control linkage member 340a and 340b respectively. The linear displacement in a push-pull like manner of the linkage control members 340 by the respective pivot member 320a and 320b is determined by the rotational orientation of the pivot members 320a and 320b. Both of the pivot members 320a and 320b move in unison as a result of them being connected by the connection arrangement 377 as shown in FIG. 14.

Rotation of the pivot members 320a and 320b is effected by the foot pedal 30. This is for example shown in FIGS. 14 and 15. In FIG. 15 a linkage mechanism is shown connecting the foot pedal 30 with the arrangement (377) to effect pivoting of pivot members 320a and 320b about the pivot axis 322. In the arrangements of FIGS. 11-16 associated with each of the control linkage members 340a and 340b are their coupling members 386a and 386b respectively. The coupling members provide input to the pivotal position of the control linkage members about the pivot axis 373 from the steering wheel.

The pivot members 320a and 320b provide and define input to the control linkage members 340a and 340b directly as a result of the position of the foot pedal 30. In the example shown with reference to FIGS. 11-16, a biasing element 394a and 394b act respectively on each of the linkage control members 340a and 340b to bias their rotational position towards the bottom of the respective slots 334a and 334b of their respective pivot members 320a and 320b.

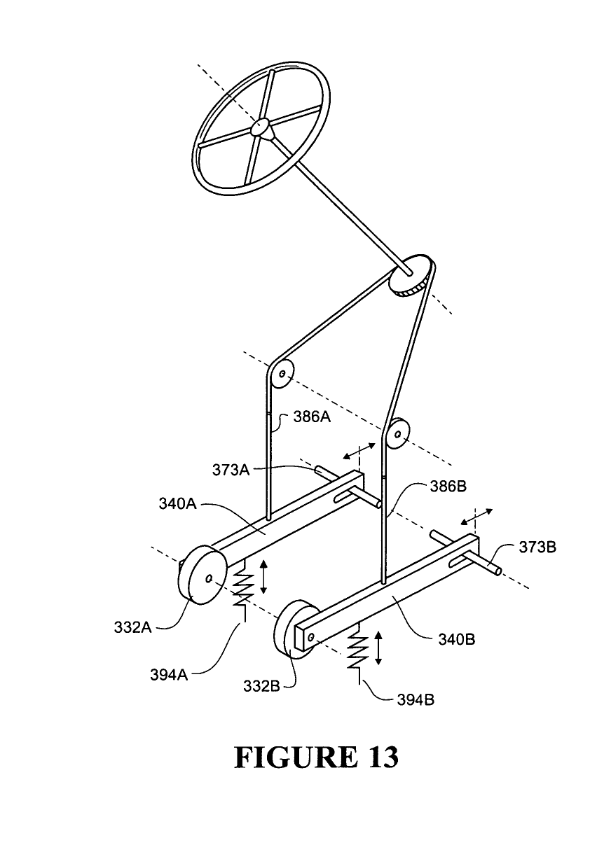

The linkage control members 340a and 340b are both linearly displaceable along their longitudinal axis and pivotable about the pivot axis 373. This may be facilitated by the provision of a slot as can be seen in FIG. 13, through which a shaft defining the pivot axis 373a and 373b on either find. Alternatively, and as shown with reference to FIG. 12, on pivotable slide bearings on 319a and 319b may be provided to facilitate both the linear and rotational motion of the linkage control members 340a and 340b.

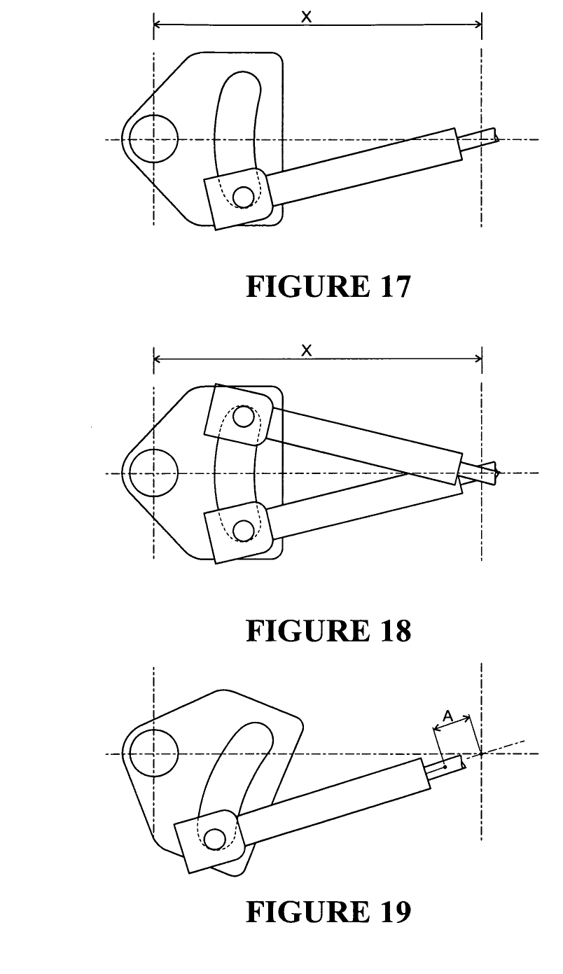

With reference to FIG. 16, where the pivot members are in a neutral position, the radius of each of the slots has its centre coinciding with the pivot axis 373 of the linkage control members. In this position, rotation of the steering wheel will not result in any pushing or pulling of the linkage control members thereby their not effecting any change in the mode of operation of the transmission elements. With the steering wheel in a neutral position (i.e. steering straight ahead) the pivot pins 332a and 332b will be at the bottom of the slot of their respective pivot members (see FIG. 17 for example). This is due to the biasing of the control linkage members by the biasing elements 394a and 394b.

With the pivot members in the neutral position, any turning of the steering wheel may move one of the control linkage members up as for example shown in FIG. 18. Given that the arc of the slot is centered at the pivot, no change in the operation of the transmissions is effected.

From their neutral position, a rotation of the pivot members in a clockwise direction will result in a displacement of the control linkage members to the left (with reference to the orientation of FIG. 16) this will result in a simultaneous change in operation of the transmission elements on both sides of the vehicle thereby accelerating the vehicle until a certain speed is reached, without turning the vehicle. This is shown in FIG. 19.

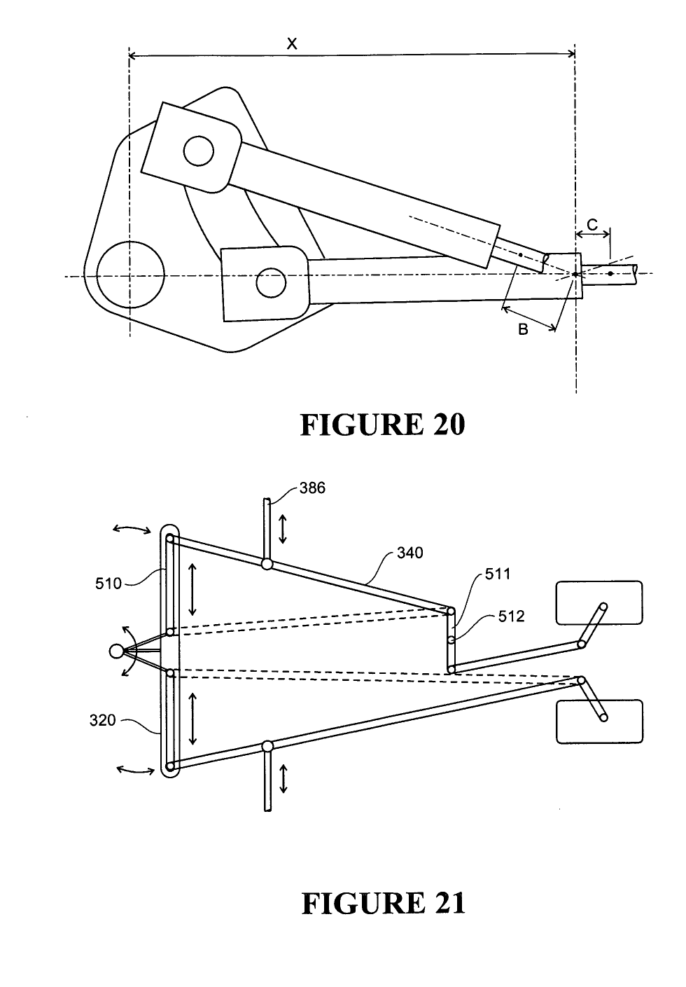

Any turning of the steering wheel will result in a pivoting in a clockwise direction of one of the control linkage members about its respective pivot 373. This is a result of a pulling upwards of the coupling member 386b on the control linkage member 340b. Due to the curvature of the slot, the control linkage member 340 will get displaced to the right of the page thereby effecting a change in operation of the transmission elements on one side of the vehicle. The other control linkage member 340a will remain at the bottom of the slot due to it being biased towards that position by its respective biasing element 394a and also due to the lost motion mechanism provided allowing for its control member 386a to not be displaced by the rotation of the steering wheel. In this way due to the relative linear displacement of the control linkage members 340a and 340b, speed can be added or subtracted from the traction elements on only one side of the vehicle or on both sides of the vehicle. FIG. 20 shows this condition but there the pivot member has been pivoted in an opposite direction from neutral, to that shown in FIG. 19. The lost motion feature may be optional.

In a zero turn condition, the steering wheel is hard over to one side. The control linkage member 340a may be at the bottom of its respective spot and the control linkage member 340b may be at the top of its respective slot. Any movement of the pedal will thereby result in a rotation of the pivot member 320a and 320b respectively about the pivot axis 322 thereby causing one of the control linkage 340 to move in a direction towards the left and the other towards the right (in respect of the orientations shown on the drawings) as a result traction elements on one side of the vehicle operate in one rotational direction and traction elements on the other side operate in the other rotational direction thereby effecting zero turn.

Another important safety feature of the product is that the product can ensure that no zero turn mode of operation can be effected when the vehicle is travelling at speed.

Reversing of the vehicle can be achieved by mounting the foot pedal so that it can rotate over a range that includes a section that results in a reversing of the motors. Both motors will then operate in reverse and drive the vehicle backwards. This can be achieved by ensuring the correct geometry is selected. The arm on the motor may have an arc of rotation that can create both forward and backwards operation of the motor.

1: A steering and drive control mechanism for a zero turn radius vehicle that includes a vehicle chassis and a pair of transmission systems for independently driving at least two traction elements that are spaced from each other and each define two parallel drive directions for driving said vehicle, said steering and drive control mechanism comprising
a drive assembly comprising
a pivoting member mounted to pivot about a pivot axis relative said chassis,
a pair of control linkage members engaged to the pivoting member in a movable manner so that the connection point for each control linkage member with said pivoting member can be moved relative said pivot axis, each said control linkage member in operative connection with a respective transmission systems to control the respective transmission system,
a foot operated pedal assembly, operatively coupled to the drive assembly so that movement of the pedal assembly results in pivotal movement of the pivoting member about the pivot axis;
a steering member pivotally connected to the vehicle chassis,
a steering assembly coupling the steering member with the control linkage members so that pivoting movement of the steering member can vary the position of one or both of the connection points of the control linkage members relative the pivot axis to thereby effect a change in operation of one of both of the transmission systems.

2: The steering and drive control mechanism as claimed in claim 1 wherein the location of each of the connection points at the pivoting member of each of the control linkage members can be varied by independently.

3: The steering and drive control mechanism as claimed in claim 1 wherein the location of each of the connection points at the pivoting member of each of the control linkage members can be varied by movement of the steering member between a position at which the connection points of both control linkage members is displaced in the same direction (and preferably at same distance) from the pivot axis of the pivoting member, to a position wherein the pivot point is intermediate of the two connection points (and are preferably spaced equidistant from the pivot point).

4: The steering and drive control mechanism as claimed in claim 1 wherein the pivoting member and the control linkage members are movably connected to each other to allow a fixed locus displacement of the control linkage members relative the pivot axis.

5: The steering and drive control mechanism as claimed in claim 1 wherein said pivoting member and each said control linkage member are connected via
a cam follower; and
a cam
the cam follower being pivotably and slideably moveable relative said cam.

6: The steering and drive control mechanism as claimed in claim 5 wherein said cam follower is fixed to the control linkage member and said cam is part of the pivoting member.

7: The steering and drive control mechanism as claimed in claim 5 wherein a said cam follower is engaged towards a distal end of each of the control linkage members.

8: The steering and drive control mechanism as claimed in claim 5 wherein the cam is a slot defined by the pivoting member into which the cam follower is located.

9: The steering and drive control mechanism as claimed in claim 5 wherein said slot is of a shape to result in a movement of each of said control linkages members upon the pivoting of said pivoting member about the pivot axis.

10: The steering and drive control mechanism as claimed in claim 9 wherein said movement is a displacement that includes a radial direction displacement relative said pivot.

11: The steering and drive control mechanism as claimed in claim 5 wherein for each cam follower a separate cam is provided.

12: The steering and drive control mechanism as claimed in claim 5 wherein the pivot axis may pass though the cam.

13: The steering and drive control mechanism as claimed in claim 12 wherein where said cam is a slot, the pivot axis passes through said slot midway between distal ends of said slot.

14: The steering and drive control mechanism as claimed in claim 1 wherein biasing means is provided to bias the control linkage members to a location relative the pivoting member where the location of the connection points in the same distance from the pivot axis.

15: The steering and drive control mechanism as claimed in claim 1 wherein the steering assembly may include
a pivotable steering column on which the steering member is mountable;
a pair of steering arms connected to the steering column; each said steering arms being operatively connected by a respective coupling member to said a said control linkage member so that movement of the steering member causes pivotal movement of the steering arms through the steering column, and hence a displacement of the control linkage member relative said pivoting member.

16: The steering and drive control mechanism as claimed in claim 1 wherein each said control linkage member is mounted relative said chassis by a mount that allow the control linkage member to displace in a manner rotationally unconstrained by said mount upon (a) the rotation of said pivoting member about the pivot axis and/or (b) movement of the steering member to vary the position of one or both of the connection points of the control linkage members relative the pivot axis.

17: The steering and drive control mechanism as claimed in claim 1 wherein said steering assembly includes a lost motion mechanism that allows steering assembly induced movement of one of the control linkage members whilst leaving idle the other control linkage member and visa versa.

18: The steering and drive control mechanism as claimed in claim 17 wherein the lost motion mechanism includes a primary arm mounted to positively rotate about a rotational axis in response to rotation of the steering member and two independent link arms rotationally mounted about said rotational axis, said primary arm including two stoppers intermediate of which said rotational axis is located, each stopper presented to engage with a respective link arm to displace said link arm in one direction of rotation about said rotational axis without acting on the other link arm, each said link arm coupled to a respective control linkage member.

19: The steering and drive control mechanism as claimed in claim 1 wherein the traction elements be wheels.

20: The zero turning radius lawnmower that includes the mechanism as claimed in claim 1.

21: The zero turning radius lawnmower, said lawnmower comprising
a pair of transmissions to drive at least two drivers independently of each other;
a chassis;
a steering and drive control mechanism as claimed in claim 1.

22: The lawnmower as claimed in claim 21 wherein the steering member is a steering wheel.

23: A steering and drive control mechanism, suitable for a vehicle that includes a vehicle chassis and at least two traction elements that are spaced from each other and each define two parallel drive directions, each said traction element associated with a respective transmission system for independently driving said traction element, each said transmission system providing a rotational input to said respective traction elements in response to movement of a controller, wherein said mechanism comprises:
for each said transmission system, a control linkage member to effect movement of the controller resultant from linear displacement of the respective control linkage member,
each said control linkage member pivotable about a pivot axis fixed relative to said chassis and biased towards one rotational direction, each control linkage member movable as a result of two inputs, namely
(i) a steering wheel that can vary the rotational disposition of each said control linkage member relative each other about said pivot,
(ii) an accelerator actuator that is movably mounted to said chassis to effect a rotation of a pivoting member about a pivot axis (herein after “second pivot axis”), said pivoting member including for each said control linkage member, a cam surface that has a first and second distal end and that is rotatable about said second pivot axis, said cam surface acting on said control linkage member via a cam follower to linearly displace its respective control linkage member.

24: The steering and drive control mechanism as claimed in claim 23 wherein the steering wheel that can vary the rotational disposition of each said control linkage member relative each other about said pivot, via a lost motion linkage between said steering wheel and each said control linkage members that:
(a) in one rotational direction of the steering wheel, can move one of said control linkage members, but not the other control linkage member, and
(b) in an opposite rotational direction of the steering wheel, can move the other said control linkage members, but not the one control linkage member.

25: The steering and drive control mechanism as claimed in claim 23 wherein rotational displacement of a said linkage control member by said steering wheel will result in a displacement of the cam follower between the first and second distal ends of the cam.

26: The steering and drive control mechanism as claimed in claim 23 wherein displacement along the cam may also result in a linear displacement of the linkage control member.

27: The steering and drive control mechanism as claimed in claim 23 wherein the cam is accurate shaped and has a centre coinciding with the first mentioned pivot axis at one rotational orientation of the pivot member.

28: The steering and drive control mechanism as claimed in claim 23 wherein in said one rotational orientation, pivotal movement of either of the control linkage members by the steering wheel will not result in a linear displacement of the control linkage member.

29: The steering and drive control mechanism as claimed in claim 23 wherein both said control linkage members are biased towards one of the first and second distal ends of their respective cam.

29: The steering and drive control mechanism as claimed in claims 24 wherein the lost motion mechanism will result in a displacement of only one of the two control linkage members away from its favoured end of the respective cam at any one time.

30: The steering and drive control mechanism as claimed in claim 27 wherein both cams have their centre off set from said pivot, at any rotational position of the pivot member other than said one rotational orientation.

31: The steering and drive control mechanism as claimed in claim 23 wherein a movement of a linkage control member by said steering wheel when said pivot member is any rotational position other than at said one rotational orientation will result in a linear displacement of said linkage control member.

32: The steering and drive control mechanism as claimed in claim 23 wherein when said pivot member is in said one rotational condition, said ends of each said cam are positioned on either side a notional line through said pivot axis and second pivot axis.

33: The vehicle that includes a drive and steering control arrangement as claimed in claim 23.

34: The vehicle that includes a drive and steering control mechanism as claimed in claim 23 wherein the vehicle is a zero turning radius vehicle.

35: The vehicle as claimed in claim 35 wherein said vehicle includes idler wheels in addition to the traction elements that drive and steer said vehicle.

36: The vehicle as claimed in claim 35 that is a lawnmower.

37: The vehicle that includes two transmissions one each for a traction element that is located to move said vehicle in a forward and backward direction in cooperation with the other traction element, said traction elements having a drive direction that is parallel the other and that is spaced from each other, where control of each transmissions occurs by the drive and steering control arrangement as claimed in claim 23.

39: A control mechanism to control the speed and direction of travel of a vehicle that includes a steering wheel and an accelerator pedal, said vehicle capable of being propelled by two spaced apart traction elements each independently driven by a respective motor, the output torque of each motor controlled by a displaceable input device, said control mechanism comprising;
a first push-pull rod having a first distal end and a second distal end, said first distal end engaged to said input device of one of said motors (hereinafter “first motor”),
a second push-pull rod having a first distal end and a second distal end, said first distal end engaged to said input device of the other of said motors (hereinafter “second motor”),
a pivot member mounted from said vehicle pivotable about a pivot axis in a manner responsive to the position of the accelerator pedal, said pivot member including at least one lever arm to which and along at least part of which at least one of said first and push-pull rod members and second push-pull rod members can traverse by being slidingly coupled thereto at or towards said second distal end, such that when said pivot member is pivoted about pivot axis, the first push-pull rod can, when in at least one position along said lever arm, displace the input device of said first motor and said second push-pull rod can, when in at least one position along said lever arm, displace the input device of said second motor,
a first coupling member operatively extending between said steering wheel and said first push-pull rod and
a second coupling member operatively extending between said steering wheel and said second push-pull rod,
wherein the movement of said steering wheel is, via said coupling members, capable of displacing both said first push-pull rod and said second push-pull rod along said lever arm to displace first push-pull rod and/or said second push-pull rod relative said pivot axis to thereby change the effective lever arm effect of said pivot member on said first push-pull rod and/or said second push-pull rod and thereby vary its effect on its respective input device.

40. The mechanism as claimed in claim 38 wherein the pivot member includes two lever arms, one for each of said first push-pull rod and said second push-pull rod, each said lever arm movable in unison.

41. The mechanism as claimed in claim 39 wherein each said first and second push-pull rods are mounted in a pivotal manner to pivot about a respective pivot axis (herein after “rod pivot”) and the pivot member defines at said lever arm(s) a path of travel there along for said first and second push-pull rods that is/are arcuate and the centre of the arc coincides, at least at one rotational position of said pivot member about its pivot axis, with said rod pivot, said one rotational condition corresponding with a parked condition of said vehicle such that any steering wheel actuated movement of the first and second push-pull rods along the arc does not displace a respective input device.
